(19) United States
(12) Patent Application Publication
(10) Pub. No.: US 2014/0101037 A1
(43) Pub. Date: Apr. 10, 2014

(54) Real-Time Authorization Interchange Surcharge

(71) Applicant: Electronic Payment Exchange, Wilmington, DE (US)

(72) Inventors: Matthew R. Ornce, Lincoln University, PA (US); Raymond Moyer, Landenberg, PA (US); Alec B. Dollarhide, Scottsdale, AZ (US)

(21) Appl. No.: 14/049,574

(22) Filed: Oct. 9, 2013

Related U.S. Application Data
(60) Provisional application No. 61/711,433, filed on Oct. 9, 2012.

(51) Int. Cl. G06Q 20/10; G06Q 20/40

(52) U.S. Cl. CPC G06Q 20/102; G06Q 20/409
USPC 705/40; 705/44

(57) ABSTRACT

A computer system for receiving an issuer's authorization for a purchase, wherein a sale amount for the purchase includes at least one interchange fee comprises a computer. The computer is configured to receive an electronic request to authorize a credit card transaction initiated by the merchant for a purchase, the authorization request including a sale amount for the purchase, determine an estimated interchange fee, compute a surcharged sale amount by adding the estimated interchange fee to the sale amount for the purchase, send a revised authorization request to the issuing bank, wherein the revised authorization request specifies the surcharged sale amount in place of the sale amount, receive an authorization response from the issuing bank indicating authorization for the purchase at the surcharged sale amount, and send the authorization response to the merchant.

### CROSS-REFERENCE TO RELATED APPLICATIONS

This application claims priority to U.S. Provisional Patent Application Ser. No. 61/711,433, filed Oct. 9, 2012, the disclosure of which is hereby incorporated by reference as if set forth in its entirety herein.

### BACKGROUND

Interchange fees are typically the fees paid by merchants to credit card companies when a customer uses a credit card to pay for a purchase. A merchant's credit card processing bank (the “acquiring bank” or “acquirer”) usually pays these interchange fees to a consumer's bank associated with the consumer's credit card (the card “issuing bank”, or “issuer”). Specifically, the issuer may deduct these interchange fees from the total transaction amount, and send the balance to the acquiring bank. The acquiring bank may then pay the merchant the amount of the transaction less the interchange fee, and less any other acquiring and processing fees due to the acquiring bank. The other acquiring and processing fees are typically significantly less than the interchange fees.

The issuer charges these fees to cover their own costs and also to make a profit. The issuer's costs may include costs associated with offering credit to consumers, paying for billing to consumers, bearing the financial risk for the transaction prior to payment by the consumer, and rewards programs offered to consumers.

The interchange fees may be calculated based on a complex combination of interchange categories that depend on the brand and type of card, the specific information included in the transaction, how and when the transaction was performed, the merchant's size and industry type, as well as other factors.

### SUMMARY

When paid by merchants, interchange fees cut into profits merchants expect based on prices they charge for goods and services. While merchants would prefer that consumers pay for these interchange fees in addition to the purchase price, there are technical challenges associated with passing along these interchange fees in real-time (i.e. at time of purchase). Specifically, interchange fees are typically calculated by the issuer well after the purchase authorization process and it is not possible to include such fees in a transaction at the point of sale. Accordingly, even if a merchant wanted to add an interchange fee to a purchase price, the merchant would not know what this interchange fee should be, let alone how to pass it along to a consumer, until after the time of purchase—which is too late in the process.

The instant application addresses this problem by providing a computer-implemented method for estimating an interchange fee during a network-based purchase authorization process. Specifically, instead of electronically requesting purchase authorization for the actual sale amount of a purchase, a computer operated by a third party, such as a payment service provider that coordinates payments between a consumer, a merchant, and an issuer, effectively intercepts the electronic authorization request and adds an estimated interchange fee to the actual sale amount to determine a surcharged sale amount. The third party computer then electronically requests a purchase authorization from the issuer, via the network, based on the surcharged sale amount, rather than the actual sale amount. An authorization response may then be sent, via the network, by the third party computer to the merchant's point of sale device (and thus also to the consumer) with the surcharged sale amount.

In one embodiment, a computer performs a computer-implemented method for processing a credit card authorization request from a merchant via a computer network. The method comprises receiving, by the computer connected to the network, from the merchant, an electronic request to authorize a credit card transaction being initiated by the merchant for a purchase. The authorization request includes a sale amount for the purchase. Next, the computer determines an estimated interchange fee based on at least one of information about the merchant, criteria determined by an issuing bank, or purchase type. The computer then computes a surcharged sale amount by adding the estimated interchange fee to the sale amount for the purchase. A revised authorization request is then sent by the computer to the issuing bank. The revised authorization request specifies the surcharged sale amount in place of the sale amount. The computer then receives an authorization response from the issuing bank indicating authorization for the purchase at the surcharged sale amount. That authorization response is then sent to the merchant's point of sale device (and thus also to the consumer). One advantage of this process is that the timing of determination of an estimated interchange fee may coincide with the credit card authorization process so that the interchange fee may be passed on to the customer at the point of sale.

In another embodiment, a batch settlement and billing computer system and associated method for minimizing interchange fees paid by a merchant includes a computer. The computer is configured to receive a settlement file from the merchant. The settlement file includes data concerning a credit card transaction. The data includes a surcharged sale amount which comprises a sale amount plus an estimated interchange fee. The computer then sends the settlement file to an issuing bank, receives from the issuing bank information specifying an actual interchange fee for the transaction, and draws from an acquiring bank funds equal to the surcharged sale amount less the actual interchange fee. Compensation for the purchase is then electronically sent to the merchant.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Exemplary embodiments will be described in connection with the associated figures, of which:

FIG. 1 illustrates a method and system for processing a credit card authorization request of the prior art;

FIG. 2 illustrates a batch settlement and billing process and system of the prior art;

FIG. 3 illustrates an embodiment of a method and system for processing a credit card authorization request for a purchase wherein authorization is sought for a surcharged sale amount that is equal to a sale amount plus an estimated interchange fee;

FIG. 4 illustrates a batch settlement and billing process and system wherein a merchant receives compensation for the purchase;

FIG. 5 illustrates embodiments of methods for calculating the surcharged sale amount and an incremental interchange cost; and

FIG. 6 is a block diagram of one embodiment of a computer system in which aspects of the disclosed systems and methods may be embodied.

### DETAILED DESCRIPTION OF ILLUSTRATIVE EMBODIMENTS

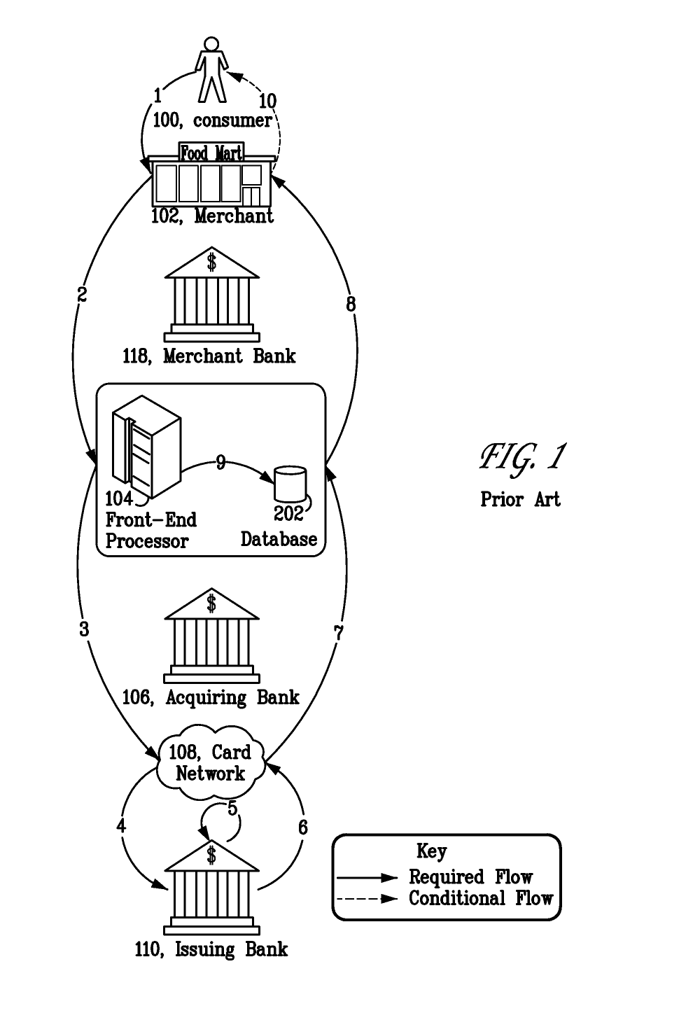

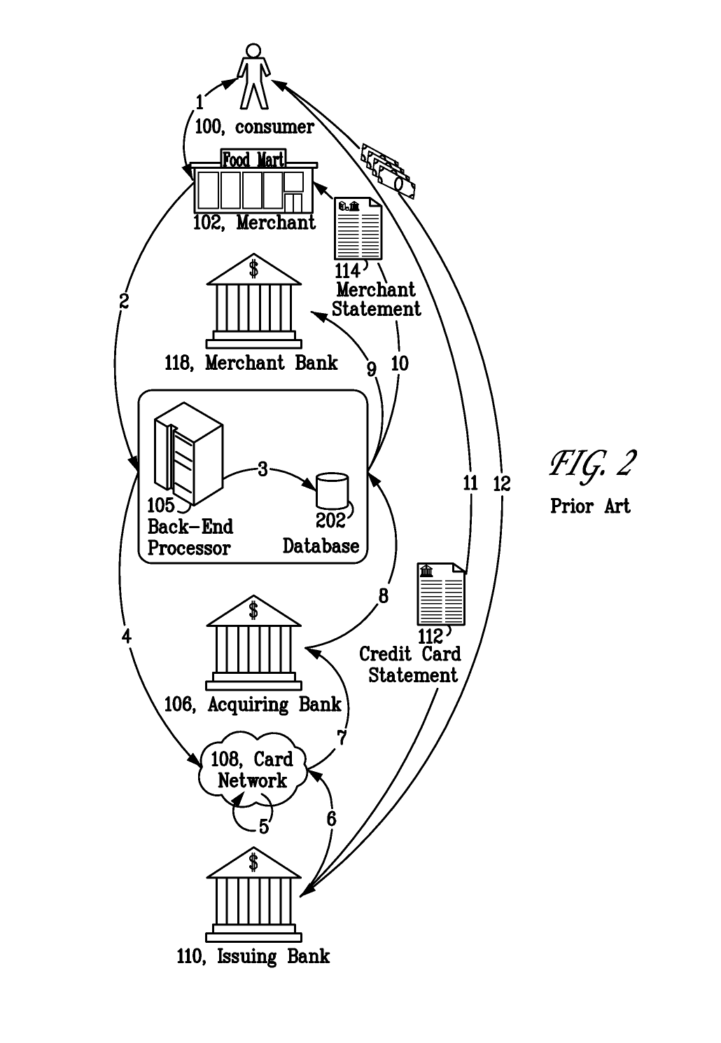

Referring now to FIGS. 1 and 2, and as mentioned above, prior art methods and systems for managing interchange fee payment typically involve a merchant 102 paying interchange fees associated with a purchase by a customer 100. A merchant 102 is an entity that sells goods and/or services to the customer 100 via a retail storefront, over the phone, through the mail, on the internet (e-commerce), etc. The customer 100 is a person or an entity that seeks to purchase goods and/or services from the merchant 102 using a credit or debit card.

As shown in FIG. 1, a front end processor 104, such as a computer, having a database 202 connects merchant 102 to a credit card network 108. A front end processor 104, along with back end processor 105 shown in FIG. 2, may be operated by an entity (or entities) that is distinct from the merchant 102 and the credit card company. Alternatively, the front end processor 104 and back end processor 105 may be operated by an entity that is the same as or otherwise associated with one or both of the merchant 102 and the credit card company. The credit card network 108 may be one of a number of credit card networks 108 for brands such as Visa®, MasterCard®, and Discover®, which run payment networks that connect front end processors 104 with that brand's issuing bank(s) 110. Specifically, network 108 manages collection and distribution of data between front end processors 104 and issuing banks 110. For example, the front end processor 104 sends authorization data from the merchant 102 to the card network 108 in order to obtain authorization from the issuing bank 110. As described in relation to FIG. 2, network 108 also settles payments from the issuing bank 110 to the acquiring bank 106. In addition to authorizing charges, issuing banks 110 may also be responsible for issuing card plastics to customers 100 and managing consumer's account balance and standing. Issuing banks may also distribute credit card statements 112, such as monthly statements. The front end processor may also operate with an issuing bank 110 directly, such as in the case where the credit card is an American Express® card.

In Step 1 of the authorization process outlined in FIG. 1, customer 100 presents a credit card to merchant 102 for payment of goods or services. Using information provided by the credit card, merchant 102 sends a purchase authorization request for the sale amount to front end processor 104 at Step 2. In Step 3, the front end processor 104 sends the purchase authorization request for the sale amount to the credit card network 108. The credit card network 108 in turn sends this request to issuing bank 110 at Step 4. At Step 5, the issuing bank 110 approves or declines the request. The card network 108 receives a response to its request from the issuing bank 110 in the form of approval or denial at Step 6. This response is sent from the card network 108 to the front end processor 104 at Step 7. At Step 8, the front end processor 104 sends the response to the merchant 102. At Step 9, front end processor 104 also stores transaction information regarding Steps 1-8 in database 202 for the settlement and billing process shown in FIG. 2. If the issuing bank 110 approves the purchase, at Step 10, customer 100 receives goods and/or services from the merchant 102.

Referring now to FIG. 2, after the authorization process described in Steps 1-8 of FIG. 1, at Step 1 of the settlement and billing process shown in FIG. 2, the customer 100 completes purchase at the merchant and receives goods and/or services. At Step 2, merchant 102 sends a settlement file to a back end processor 105, such as a computer. At Step 3, the back end processor 105 computes an estimated interchange category and fee based on information in the merchant's settlement file and additional authorization information from the database 202. The back end processor 105 then sends a card network settlement file to the card network 108 at Step 4. At Step 5, the card network 108 computes an actual interchange category and fee. Interchange fees may be computed by applying a percentage rate to the transaction total and/or a per transaction fee, based on the interchange category that the transaction qualified for. For example, these fees generally range from 1% to 3% of the purchase price and $0.10 to $1.50 per transaction.

Interchange fees may be based on a complex combination of interchange categories that may depend on the brand and type of card, the specific information included in the transaction, how and when the transaction was performed, the merchant's size and industry type, as well as other factors. In order for a transaction to qualify for a specific interchange category, certain qualification criteria may be required. The qualification criteria may be established by the card brands and/or the debit networks. Transactions that do not qualify for the intended interchange category may be downgraded to a more costly interchange category to offset the issuer's increased risk. In some very low dollar value transactions, the interchange and other acquiring and processing fees may actually exceed the transaction dollar value. As the dollar value of the transaction increases, the interchange basis points may also substantially erode merchant profit.

Referring now to Step 6 of FIG. 2, the card network 108 then draws settlement funds from the issuing bank 110. Thereafter, the card network 108 sends the settlement funds less the actual interchange fee to an acquiring bank 106 at Step 7. At Step 8, the back end processor 105 draws settlement funds, less the actual interchange fee and any other fees, such as an acquiring fee, from the acquiring bank 106. At Step 9, the back end processor 105 then sends compensation for the purchase to a merchant's bank 118. The merchant's bank 118 is a financial institution where the merchant 102 maintains an account. At Step 10, the merchant 102 receives a merchant statement 114 from the back end processor 105 that includes information about the interchange fee. At Step 11, the customer 100 receives a credit card statement 112 from the issuing bank 110. The consumer pays fees associated with the credit card statement 112 to the issuing bank 110 at Step 12.

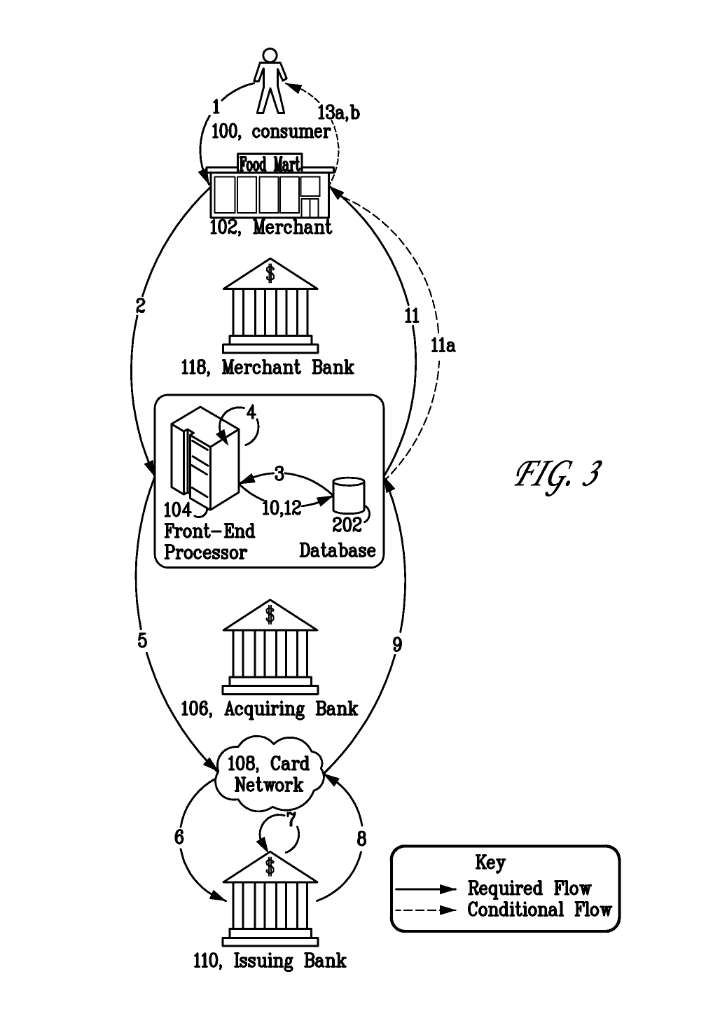

A detailed description of illustrative embodiments of methods and systems relating to obtaining authorization for purchases of goods and services will now be described with reference to FIGS. 3-6. Although this description provides detailed examples of possible implementations, it should be noted that the details are intended to be exemplary and in no way limit the scope of the application.

FIG. 3 illustrates an example embodiment of an improved authorization process in which an issuing bank 110 receives a purchase authorization request based on a surcharged purchase price that includes the actual purchase price plus an estimated interchange fee. Through this improved process, the customer 100 pays at least a portion of the interchange fee associated with the purchase.

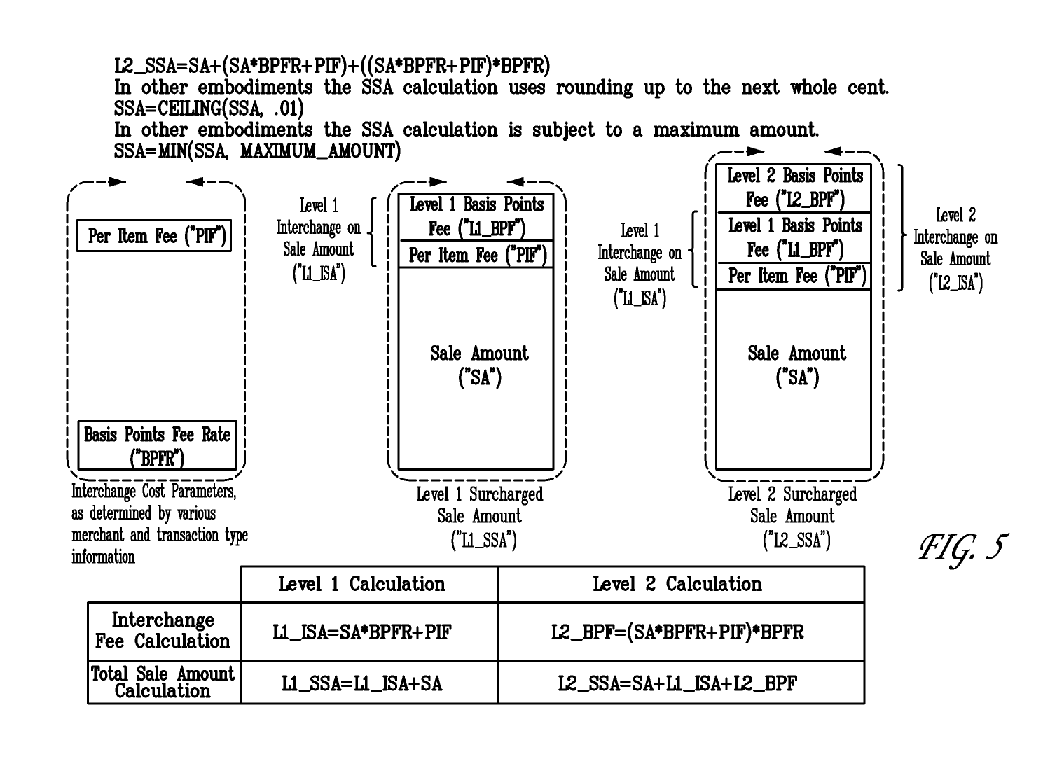

At Step 1 of FIG. 3, the customer 100 presents a credit card to merchant 102 for payment of goods or services. Using information provided by the credit card, merchant 102 sends a purchase authorization request for the sale amount to front end processor 104 at Step 2. In Step 3, and as described in greater detail in relation to FIG. 5, the front end processor 104 retrieves pre-established information to determine the most likely interchange category for the purchase. At Step 4, the front end processor 104 calculates an estimated interchange fee, based at least in part on the pre-established information, and adds this estimated interchange fee to the sale amount to form a surcharged sale amount. In some embodiments (not shown), the estimated interchange fee may be calculated by other entities, such as the merchant 102, the card network 108, the issuing bank 110, the acquiring bank 106, the merchant's bank 118, the back end processor 105, or some combination thereof. In other embodiments (also not shown), the interchange fee added to the purchase price is an actual interchange fee calculated at the time of the authorization process by the front end processor 104, the back end processor 105, the merchant 102, the card network 108, the issuing bank 110, the acquiring bank 106, the merchant's bank 118, or some combination thereof.

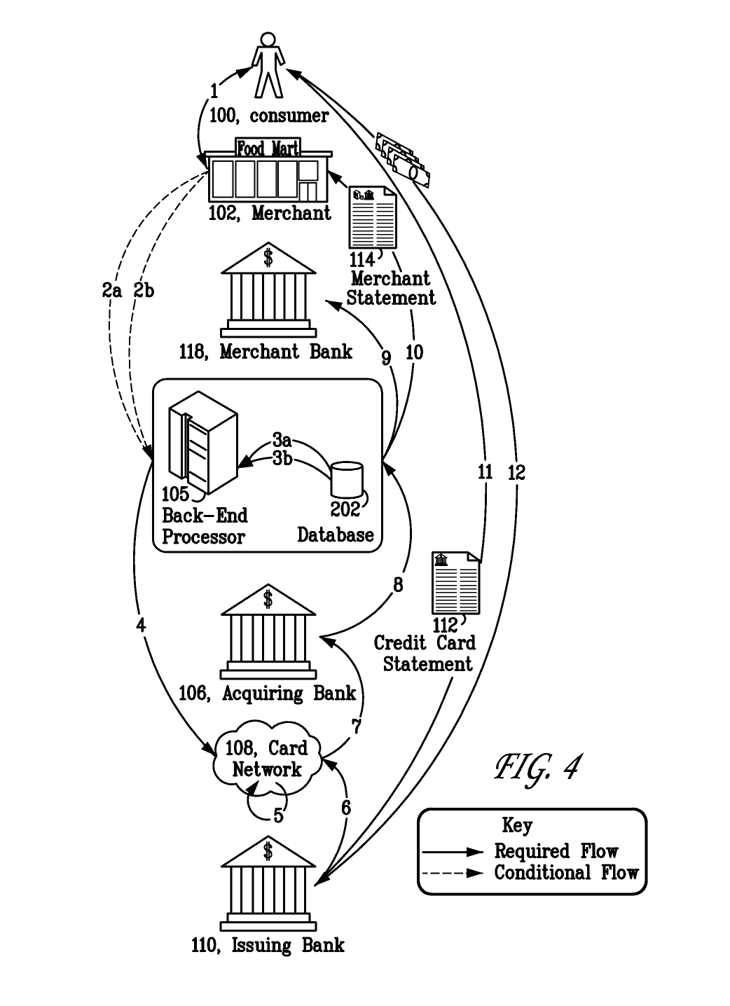

The front end processor 104 then sends an authorization request for the surcharged sale amount to the card network 108 at Step 5. The credit card network 108 in turn sends this request to the issuing bank 110 at Step 6. At Step 7, the issuing bank 110 approves or declines the request. The card network 108 receives a response to its request from the issuing bank 110 in the form of approval or denial at Step 8. This response is sent from the card network 108 to the front end processor 104 at Step 9. At Step 10, front end processor 104 also stores transaction information in database 202 for the settlement and billing process shown in FIG. 4. The front end processor 104 sends the response to the merchant 102 at Step 11.

If the issuing bank 110 approves the purchase, at Step 11a, the front end processor 104 also sends information about the estimated interchange fee to the merchant 102. The information about the estimated surcharge fee may be sent with the response to the authorization request or separately from the response to the authorization request. When information about the estimated surcharge fee is sent with the response to the authorization request, or at approximately the same time as the response to the authorization request, such as prior to the customer 100 receiving a receipt, the information may be said to be provided in real-time. Specifically, information about the estimated interchange fee is provided in real-time to the merchant 102 (and in some embodiments, also the customer 100) during the authorization process at the time of purchase. For example, information about the estimated interchange fee is sent to the merchant 102 in real-time before the customer 100 leaves the point of sale (in the case of a brick and mortar store front) or prior to shipment of goods (in relation to telephone, mail order, or internet-based retailers). Providing the estimated interchange fee in real-time contrasts with the prior art processes shown in FIGS. 1 and 2 in which an estimated interchange fee is not computed until Step 3 of FIG. 2, which occurs after the authorization process (i.e. after the time of purchase). Because the prior art does not calculate the estimated interchange fee until after the authorization process, neither the merchant 102, nor the customer 100, may be made aware of the estimated interchange fee before the customer 100 receives the goods and/or services in exchange for payment.

Referring again to FIG. 3, at Step 12, front end processor 104 stores the estimated interchange fee with merchant and transaction information in database 202. At Step 13a, the merchant 102 may provide information on the estimated interchange fee to the consumer as indicated by an actual cost on the consumer's receipt. At Step 13b, the consumer receives the goods and/or services from the merchant 102.

FIG. 4 depicts an example embodiment of an improved settlement and billing process that corresponds to the improved authorization process shown in FIG. 3. Through this improved settlement and billing process, the merchant avoids paying at least a portion of the interchange fee associated with the purchase. After the authorization process described in relation to FIG. 3, at Step 1 of the settlement and billing process shown in FIG. 4, the customer 100 completes purchase at the merchant 102 and receives goods and/or services. After Step 1, the merchant 102 may do one of two things. In a first embodiment, at Step 2a, the merchant 102 sends a settlement file with the original sale amount to a back end processor 105. In a second embodiment, at Step 2b, the merchant 102 sends a settlement file with the surcharged sale amount as calculated in Step 4 of FIG. 3 to the back end processor 105.

Depending on whether the merchant 102 proceeds according to Step 2a or Step 2b, back end processor 105 may do one of two things. If merchant 102 followed Step 2a, the back end processor 105 updates the settlement file by replacing the original sale amount with the surcharged sale amount as calculated in Step 4 of FIG. 3. If merchant 102 followed Step 2b, the back end processor 105 does not update the settlement file with the surcharged sale amount because the settlement file already contains the surcharged sale amount.

Once the settlement file contains the surcharged sale amount, the back end processor 105 then sends the settlement file to the card network 108 at Step 4. At Step 5, the card network 108 computes an actual interchange category and fee. At Step 6 of FIG. 4, the card network 108 then draws settlement funds equal to the surcharged sale amount calculated in Step 4 of FIG. 3 from the issuing bank 110. The card network 108 then sends the settlement funds less the actual interchange fee to an acquiring bank 106 at Step 7. At Step 8, the back end processor 105 draws settlement funds, less the actual interchange fee and any other fees, such as an acquiring fee, from the acquiring bank 106. At Step 9, the back end processor 105 then sends compensation for the purchase to a merchant's bank 118. At Step 10, the merchant 102 receives a merchant statement 114 from the back end processor 105 that includes information about the interchange fee. In some embodiments, differences between the estimated interchange fee charged to the customer 100 and the actual interchange fee calculated by the card network 108 is the merchant's profit or loss. In other embodiments, differences between the estimated interchange fee charged to the customer 100 and the actual interchange fee calculated by the card network 108 may pass to the third party operator of the front end processor 104. At Step 11, the customer 100 receives a credit card statement 112 from the issuing bank 110, such as a monthly statement. The consumer pays fees associated with the credit card statement 112 to the issuing bank 110 at Step 12, for example, on a monthly basis.

Referring now to FIG. 5, which depicts a method for estimating interchange fees described above in relation to Step 4 of FIG. 3, an example embodiment of a method for calculating an estimated interchange fee, and the total sale amount is shown. The front end processor 104 may determine the most likely interchange category for a transaction based on certain data received from the issuing bank. For example, certain data typically received with financial transaction authorization requests for a particular merchant 102 could be stored with that merchant's profile at a front end processor 104 and or database 202. Based on that information, the front end processor 104 may estimate the interchange fee. Data for each particular merchant may be pre-populated and stored with that merchant's profile. With that data, the front end processor 104 may compute the estimated interchange fees and the surcharged sale amount.

Once the interchange category is determined, that interchange category's fee can be calculated. Interchange fees consist of a combination of 2 independent parts: basis points, which may be represented as a percentage of the sale, and/or a static per transaction fee. In an exemplary embodiment, the Level 1 Interchange on the Sale Amount (“L1_ISA”) is calculated given the Sale Amount (“SA”), the Basis Points Fee Rate (“BPFR”) and Per Item Fee (“PIF”) of the selected Interchange program:

L1_ISA=(SA*BPFR)+PIF

The resultant L1_ISA value may be added to the SA, and provided to the card network 108 as the Level 1 surcharged sale amount (“L1_SSA”) for approval in real-time in place of the sale amount originally provided by the merchant.

In another embodiment, the surcharged sale amount may be computed with greater accuracy to also include an incremental interchange cost of the L1_ISA. An incremental interchange cost compensates for the difference between the original sale amount and the surcharged sale amount. In other words, because the surcharged sale amount is greater than the original sale amount, the actual interchange fee for the surcharged sale amount will be greater than an interchange fee would have been for the original sale amount. The incremental interchange cost captures at least some of the difference between an estimated interchange fee based on the original sale amount and the higher actual interchange fee based on the surcharged sale amount. In this way, including the incremental interchange cost in the surcharged sale amount provides for the customer 100 to bear as fully as possible the cost of the transaction's actual interchange fees.

The Level 2 Interchange on the Sale Amount (“L2_ISA”) may be calculated given the Sale Amount (“SA”), the Basis Points Fee Rate (“BPFR”) and Per Item Fee (“PIF”) of the selected Interchange program:

L2_ISA=(SA*BPFR+PIF)+((SA*BPFR+PIF)*BPFR)

The resultant L2_ISA value may be added to the SA, and provided to the issuer as the Level 2 surcharged sale amount (“L2_SSA”) for approval in real-time in place of the sale amount originally provided by the merchant.

In other embodiments, the Surcharged Sale Amount (“SSA”) calculation may also be subject to other non-Interchange related surcharges, such as a Non-Interchange Per Item Fee (“NIPIF”) and/or a Non-Interchange Basis Points Fee Rate (“NIBPFR”). This Non-Interchange Surcharge on the Sale Amount (“NISSA”) could be calculated given the Sale Amount (“SA”), the NIBPFR and NIPIF as determined by the merchant:

NISSA=(SA*NIBPFR)+NIPIF

In another embodiment, the Non-Interchange Surcharge on the Sale Amount (“NISSA”) could be calculated using the Surcharged Sale Amount (“SSA”).

NISSA=(SSA*NIBPFR)+NIPIF

In an exemplary embodiment, the NISSA may be combined with the SA and/or either of the L1_SSA or the L2_SSA and provided to the issuer as the SSA for approval in real-time in place of the sale amount originally provided by the merchant.

In other embodiments, the SSA calculation may use rounding up to the next whole cent, such that the resultant ISA value may be rounded up to the next 1/100^{th} value for any values greater than 1/1000.

SSA=CEILING(SSA,0.01)

In other embodiments, the SSA calculation may be subject to a maximum amount, regardless of how the maximum amount is computed.

SSA=MIN(SSA,MAXIMUM_AMOUNT)

The embodiments described above with respect to FIGS. 3-5, may also be modified or augmented in various manners. For example, the disclosed embodiments may be comprised of transaction responses with various data fields relating to interchange category and fee wherein the method in which the responses are delivered to the merchant may include the exporting of data at a later date.

Further, the disclosed embodiments may include a field in the transaction response that signifies the name of the estimated interchange category/program. For example, a name of an estimated interchange category may be “Business Core T&E Rate I”.

The disclosed embodiments may also include a field in the transaction response that signifies an identification of the estimated Interchange category/program that relates back to a textual description of the estimated Interchange category/program. For example, an identification such as “US558” may relate back to “Business Core T&E Rate I”.

The disclosed embodiments may include fields in the transaction response that signify the estimated interchange fee based on the transaction amount and the estimated interchange category. For example, fields for Basis Points Fee Rate (“BPFR”), Per Item Fee (“PIF”), Interchange on Sale Amount (“ISA”), and Surcharged Sale Amount (“SSA”) may be included in the transaction response. A BPFR field may include “1.8000” which relates to the Interchange category's percentage rate applied to the dollar amount of the transaction. A PIF field may include “0.10” which relates to the interchange category's fee per transaction. An ISA field may include “1.67” which relates to the transaction's total interchange cost (the interchange category's percentage and per transaction fee applied to the transaction). An SSA field may include “21.67” which relates to the transaction's total Interchange cost (the interchange category's percentage and per transaction fee applied to the transaction) and the Sale Amount (“SA”).

Further, an authorization response to merchant 102 may include a date signifying when the estimated interchange fee was valid through/until. One factor that may affect interchange fee estimations may be how long after a transaction is authorized that it may still be settled without qualifying at a lower rate. Risk—and therefore interchange costs—may increase as the time between a transaction's authorization and settlement date grows. The disclosed embodiments may include a date field in the transaction response that signifies the date when the estimated qualification is valid through/until. This information may be used by merchants as an indicator of possible changes required to their business practices to reduce interchange costs. For example, a merchant 102 typically ships goods 4 days after authorization. The “valid through/until” date field is a date 2 days after the authorization. In order to increase the likelihood that the estimated interchange fee is close to the actual interchange fee, the merchant 102 may seek to settle the purchase sooner. Reducing the number of days between authorization and shipment may require changes to their business practices, in this case by shipping sooner.

Also, the disclosed embodiments may include a field in the transaction request that signifies the merchant's desire to send additional fields back in the response that may not otherwise be sent. In other words, response to the merchant 102 may include verbose setting to influence response contents.

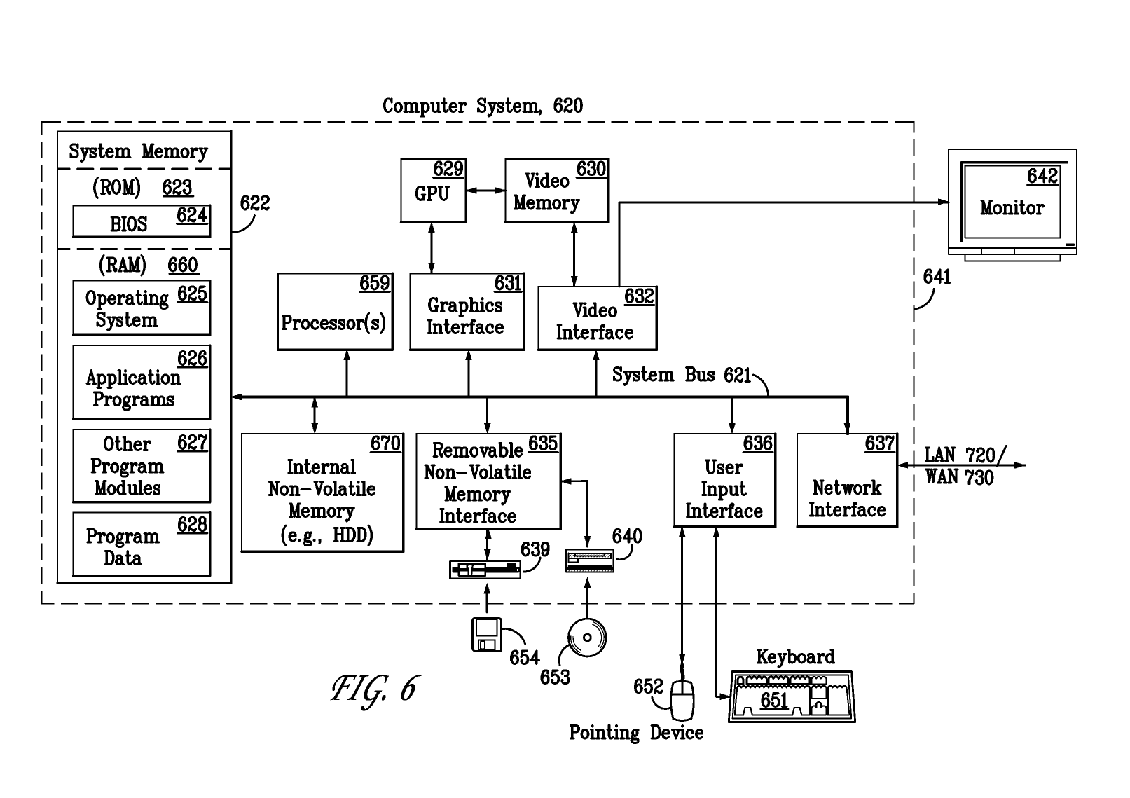

Referring now to FIG. 6, a block diagram of an example computer system 620 on which the embodiments described herein and/or various components thereof, such as front end processor 104 and back end processor 105 may be implemented. For example, the functions performed by the entities described in the various embodiments above may be performed by one or more such example computer systems. For example, the system described herein may be implemented in software (i.e., computer executable instructions or program code) executing on one or more such computer systems 620. It is understood, however, that the computer system 620 is just one example of a suitable computing environment and is not intended to suggest any limitation as to the scope of use or functionality of the presently disclosed subject matter. Neither should the computer system 620 be interpreted as having any dependency or requirement relating to any one or combination of components illustrated in FIGS. 3 and 4. In some embodiments, the various depicted computing elements may include modules or components configured to instantiate specific aspects of the present disclosure.

For example, the components used in this description may include specialized hardware components configured to perform function(s) by firmware or switches. In other example embodiments, components may include a general purpose processor, memory, etc., configured by software instructions that embody logic operable to perform function(s). In example embodiments where modules or components include a combination of hardware and software, an implementer may write source code embodying logic and the source code may be compiled into machine readable code that can be processed by the general purpose processor. Since the state of the art has evolved to a point where there is little difference between hardware, software, or a combination of hardware/software, the selection of hardware versus software to effectuate specific functions is a design choice left to an implementer. More specifically, a software process may be transformed into an equivalent hardware structure, and a hardware structure may itself be transformed into an equivalent software process. Thus, the selection of a hardware implementation versus a software implementation is one of design choice and left to the implementer.

In FIG. 6, the computer system 620 comprises a computer 641, which may include a variety of computer readable media. Computer readable media may be available media that may be accessed by computer 641 and may include volatile and/or nonvolatile media, removable and/or non-removable media. The system memory 622 may include computer storage media in the form of volatile and/or nonvolatile memory such as read only memory (ROM) 623 and random access memory (RAM) 660. A basic input/output system 624 (BIOS), containing the basic routines that help to transfer information between elements within computer 641, such as during start-up, may be stored in ROM 623. RAM 660 may contain data and/or program modules that are immediately accessible to and/or presently being operated on by processing unit 659. By way of example, and not limitation, FIG. 6 illustrates operating system 625, application programs 626, other program modules 627, and program data 628. As a further example, video content (e.g. video frames) and/or metadata (e.g. closed caption data), in one embodiment, may be stored in the system memory 622, as well as in any of a variety of non-volatile memory media discussed herein.

The computer 641 may also include other removable/non-removable, volatile/nonvolatile computer storage media. By way of example, the computer 641 may include a hard disk drive 670 that reads from or writes to non-removable, nonvolatile magnetic media, a magnetic disk drive 639 that reads from or writes to a removable, nonvolatile magnetic disk 654, and an optical disk drive 640 that reads from or writes to a removable, nonvolatile optical disk 653 such as a CD ROM or other optical media. Other removable/non-removable, volatile/nonvolatile computer storage media that can be used in the exemplary operating environment include, but are not limited to, magnetic tape cassettes, solid-state drives, flash memory cards, digital versatile disks, digital video tape, solid state RAM, solid state ROM, and the like. Magnetic disk drive 639 and optical disk drive 640 may be connected to the system bus 621 by a removable memory interface, such as interface 635. The drives and their associated computer storage media discussed herein, may provide storage of computer readable instructions, data structures, program modules and other data for the computer 641.

A user may enter commands and information into the computer 641 through input devices such as a keyboard 651 and/or pointing device 652, commonly referred to as a mouse, trackball, or touch pad. Other input devices (not shown) may include a microphone, joystick, game pad, satellite dish, scanner, or the like. These and other input devices may be connected to the processing unit 659 through a user input interface 636 that is coupled to the system bus, but may be connected by other interface and/or bus structures, such as a parallel port, game port, or a universal serial bus (USB) for example. The computer may connect to a local area network or wide area network, such as LAN 720 and/or WAN 730, through a network interface or adapter 637.

As is apparent from the embodiments described herein, all or portions of the various systems, methods, and aspects of the present invention may be embodied in hardware, software, or a combination of both. When embodied in software, the methods and apparatus of the present invention, or certain aspects or portions thereof, may be embodied in the form of program code (i.e., computer executable instructions). This program code may be stored on a computer-readable storage medium, such as a magnetic, electrical, or optical storage medium, including without limitation a floppy diskette, CD-ROM, CD-RW, DVD-ROM, DVD-RAM, magnetic tape, flash memory, solid-state drive, hard disk drive, or any other machine-readable storage medium, wherein, when the program code is loaded into and executed by a machine, such as a computer or server, the machine becomes an apparatus for practicing the invention. A computer on which the program code executes may include a processor, a storage medium readable by the processor (including volatile and/or nonvolatile memory and/or storage elements), at least one input device, and/or at least one output device. The program code may be implemented in a high level procedural or object oriented programming language. Alternatively, the program code may be implemented in an assembly or machine language. In any case, the language may be a compiled or interpreted language. When implemented on a general-purpose processor, the program code may combine with the processor to provide a unique apparatus that operates analogously to specific logic circuits. As used herein, the terms “computer-readable medium” and “computer-readable storage medium” refer to physical, non-transitory storage media and do not encompass transitory media, such as signals.

As the foregoing illustrates, the present invention is directed to systems, methods, and apparatus for to providing information about a playground installation. Changes may be made to the embodiments described above without departing from the broad inventive concepts thereof. Accordingly, the present invention is not limited to the particular embodiments disclosed, but is intended to cover all modifications that are within the spirit and scope of the invention as defined by the appended claims.

What is claimed:

1. A computer-implemented method for processing a credit card authorization request from a merchant via a computer network, the method comprising:
receiving, by a computer connected to the network from the merchant, an electronic request to authorize a credit card transaction being initiated by the merchant for a purchase, the authorization request including a sale amount for the purchase;
determining, by the computer, an estimated interchange fee based on at least one of information about the merchant, criteria determined by an issuing bank, or purchase type;
computing, by the computer, a surcharged sale amount by adding the estimated interchange fee to the sale amount for the purchase;
sending, by the computer, a revised authorization request to the issuing bank, wherein the revised authorization request specifies the surcharged sale amount in place of the sale amount;
receiving, by the computer, an authorization response from the issuing bank indicating authorization for the purchase at the surcharged sale amount; and
sending, by the computer, the authorization response to the merchant.

2. The method of claim 1 wherein the step of determining, by the computer, the estimated interchange fee includes determining a percentage of the sale amount and determining a per item fee; and
the step of computing, by the computer, the surcharged sale amount includes adding the percentage of the sale amount and the per item fee to the sale amount.

3. The method of claim 1 further comprising a step of determining, by the computer, an incremental interchange cost of the estimated interchange fee based on at least one of information about the merchant, criteria determined by the issuing bank, or purchase type;
wherein the step of computing, by the computer, the surcharged sale amount includes also adding the incremental interchange cost to the sale amount for the purchase.

4. The method of claim 3 wherein the incremental interchange cost is based on pre-determined criteria provided by the issuing bank.

5. The method of claim 1 further comprising:
receiving, by the computer, a settlement file from the merchant, the settlement file including data concerning the credit card transaction;
sending, by the computer, the settlement file to the issuing bank;
receiving, by the computer from the issuing bank, information specifying an actual interchange fee for the transaction;
drawing, by the computer, from an acquiring bank funds equal to the surcharged sale amount less the actual interchange fee; and
sending, by the computer to the merchant compensation for the purchase.

6. A computer system for processing a credit card authorization request from a merchant via a computer network, the computer system comprising:
a computer connected to the network and configured to:
receive an electronic request to authorize a credit card transaction being initiated by the merchant for a purchase, the authorization request including a sale amount for the purchase;
determine an estimated interchange fee based on at least one of information about the merchant, criteria determined by an issuing bank, or purchase type;
compute a surcharged sale amount by adding the estimated interchange fee to the sale amount for the purchase;
send a revised authorization request to the issuing bank, wherein the revised authorization request specifies the surcharged sale amount in place of the sale amount;
receive an authorization response from the issuing bank indicating authorization for the purchase at the surcharged sale amount; and
send the authorization response to the merchant.

7. The computer system of claim 6 wherein the computer is further configured to determine the estimated interchange fee by determining a percentage of the sale amount and determining a per item fee; and
to compute the surcharged sale amount by adding the percentage of the sale amount and the per item fee to the sale amount.

8. The computer system of claim 6 wherein the computer is further configured to determine an incremental interchange cost of the estimated interchange fee based on at least one of information about the merchant, criteria determined by the issuing bank, or purchase type; and
compute the surcharged sale amount by also adding the incremental interchange cost to the sale amount for the purchase.

9. The computer system of claim 8 wherein the incremental interchange cost is based on pre-determined criteria provided by the issuing bank.

10. The computer system of claim 6 wherein the computer is further configured to:
receive a settlement file from the merchant, the settlement file including data concerning the credit card transaction;
send the settlement file to the issuing bank;
receive from the issuing bank information specifying an actual interchange fee for the transaction;
draw from an acquiring bank funds equal to the surcharged sale amount less the actual interchange fee; and
send to the merchant compensation for the purchase.

11. A computer-implemented batch settlement and billing process comprising:
receiving, by a computer, a settlement file from a merchant, the settlement file including data concerning a credit card transaction for a purchase;
sending, by the computer, the settlement file to an issuing bank, wherein data in the settlement file includes a surcharged sale amount, the surcharged sale amount comprising a sale amount plus an estimated interchange fee;
receiving, by the computer from the issuing bank, information specifying an actual interchange fee for the transaction;
drawing, by the computer, from an acquiring bank funds equal to the surcharged sale amount less the actual interchange fee; and
sending, by the computer to the merchant compensation for the purchase.

12. The process of claim 11 wherein the step of receiving, by the computer, the settlement file from the merchant includes receiving data in the settlement file that includes the surcharged sale amount.

13. The process of claim 11 further comprising a step of adding to the settlement file received from the merchant data that includes the surcharged sale amount prior to the step of sending, by the computer, the settlement file to the issuing bank.

14. The process of claim 11 further comprising a step of sending, by the computer, a merchant statement to the merchant, the merchant statement including information regarding a comparison between the estimated interchange fee and the actual interchange fee.

15. The process of claim 11 wherein the estimated interchange fee is determined by the computer based on at least one of information about the merchant, criteria determined by the issuing bank, or purchase type.

16. The process of claim 11 further comprising a step of receiving from the merchant via the computer proof of a consumer's consent to the surcharged sale amount.

17. The process of claim 16 further comprising a step of sending to the issuing bank via the computer proof of a consumer's consent to the surcharged sale amount.

18. A batch settlement and billing computer system for minimizing interchange fees paid by a merchant, the system comprising:
a computer, the computer being configured to:
receive a settlement file from the merchant, the settlement file including data concerning a credit card transaction for a purchase;
send the settlement file to an issuing bank, wherein data in the settlement file includes a surcharged sale amount, the surcharged sale amount comprising a sale amount plus an estimated interchange fee;
receive from the issuing bank, information specifying an actual interchange fee for the transaction;
draw from an acquiring bank funds equal to the surcharged sale amount less the actual interchange fee; and
send to the merchant compensation for the purchase.

19. The computer system of claim 18 wherein the step of receiving, by the computer, the settlement file from the merchant includes receiving data in the settlement file that includes the surcharged sale amount.

20. The computer system of claim 18 further comprising a step of adding to the settlement file received from the merchant data that includes the surcharged sale amount prior to the step of sending, by the computer, the settlement file to the issuing bank.

21. The computer system of claim 18 wherein the computer is further configured to send a merchant statement to the merchant, the merchant statement including information regarding a comparison between the estimated interchange fee and the actual interchange fee.

22. The computer system of claim 21 wherein the estimated interchange fee is determined by the computer based on at least one of information about the merchant, criteria determined by the issuing bank, or purchase type.

23. The computer system of claim 18 wherein the computer is further configured to receive from the merchant proof of a consumer's consent to the surcharged sale amount.

24. The computer system of claim 23 wherein the computer is further configured to send to the issuing bank proof of a consumer's consent to the surcharged sale amount.
